(19) United States
(12) Patent Application Publication
(10) Pub. No.: US 2015/0169295 A1
(43) Pub. Date: Jun. 18, 2015

(54) Design Assistance Device for Control Software

(71) Applicants: Tsukasa Kyoso, Tokyo (JP); Yoshitaka Atarashi, Tokyo (JP); Takeshi Fukuda, Tokyo (JP)

(72) Inventors: Tsukasa Kyoso, Tokyo (JP); Yoshitaka Atarashi, Tokyo (JP); Takeshi Fukuda, Tokyo (JP)

(73) Assignee: Hitachi, Ltd., Chiyoda-ku, Tokyo (JP)

(21) Appl. No.: 14/409,191

(22) PCT Filed: Jun. 20, 2012
(86) PCT No.: PCT/JP2012/065677

§ 371 Date: Dec. 18, 2014

(51) Int. Cl. G06F 9/44; G06F 11/36

(52) U.S. Cl. CPC G06F 8/34; G06F 11/3604

(57) ABSTRACT

In automatically generating a source code from a block diagram, it is essential to efficiently confirm the validity of the source code that is converted from the block diagram, and also in cases of starting usage of a new code generating tool, it is important to efficiently confirm the validity of that code generating tool. In order to perform this task, the design assistance device for software of the present invention automatically generates source code based on a block diagram describing the processing procedure for controlling a device for control by utilizing plural block elements and the connective relation between those plural block elements. The design assistance device for software generates a first data flow expressing the block diagrams and their connective relation by using nodes and links; generates a second data flow expressing the dependent relation among functions or variables in the source code by utilizing nodes and links; and finds and outputs the coincidence between the first data flow and second data flow.

### TECHNICAL FIELD

The present invention relates to a software analysis program ideal for assistance of software development, verification, and maintenance.

### BACKGROUND ART

Embedded control devices that control the target objects for control utilize so-called embedded software in technical fields such as automotive, construction machinery, and elevators. Embedded software offers the advantage of flexibility and high level control compared to methods of the related art that function by way of equipment mechanisms or electrical circuits and also that a large number of derivative products can be developed by making localized changes in the software.

In recent years, along with control processing required for embedded control devices that become more complex year by year, the dependency relation among control variables is becoming more complicated making software development difficult. On the other hand, demands are also being made to shorten the software development cycle Meeting this demand for developing large and complicated software in a short period of time requires smoothly and efficiently developing software from design materials.

In order to resolve this problem, a model base development technology is proposed that writes algorithms from block diagrams combining plural blocks defined by each single item in the process content and generates a source code from the block diagram in a computer language.

However, unless restrictions are placed on the writing of algorithms from block diagrams, the algorithm writing might become extremely flexible causing concern that generating a source code from the block diagram based on specified rules might lead to the source code deviating from the designer's intentions. Whereupon a technology is for example disclosed in Patent Literature 1 for verifying the block diagram being made prior to generating the source code in order to enhance design quality by ensuring the validity of the source code that is generated.

In the related art in Patent Literature 1, besides storing a decision result on the validity of the source code generated from a block diagram, the disclosed technology informs the designer when there is a match between the block diagram being made, and a past block diagram where a problem previously occurred. By accumulating these types of past design cases, restrictions can be placed on the block diagrams that are generated and the quality of the source code generated from the block diagram can be assured.

### CITATION LIST

### Patent Literature

Patent literature 1: Japanese Unexamined Patent Application Publication 2011-13837

### SUMMARY OF INVENTION

### Technical Problem

After deciding whether or not the source code generated from the block diagram is valid in term of the designer's intentions or violates the designer's intention, the above-described technology of the related art must accumulate design cases from the past.

However, verifying whether the source code operates according to the designer's intentions or not is a decision that must be made by the designer himself and as the size of the design cases becomes ever larger, the time and trouble required for this verifying operation also becomes larger.

Moreover, the source code generated from the block diagram is dependent on the quality of the code generator tool or namely the software for carrying out conversion between the block diagram and source code. The content of the source code generated from the block diagram sometimes changes for example, when the code generator tool version is changed or the code generator tool itself is changed to a different type, etc. In such cases, the validity of the generated source code is still not confirmed even for design cases for block diagrams whose generated source code validity is already verified, so an operation to check the validity of the generated source code in the case of past block diagrams is again required. The operation to check the validity of the generated source code in each and every block diagram must be carried out to match the number of past design cases so the more abundant the design cases, the greater the difficultly in make changes in the code generator tool.

However, enhanced performance and efficiency of the program code can also be expected in the case of code generator tool changes and version upgrades so that if the time and trouble of verifying the validity as described above could be reduced then there will be demands to change the code generator tool to the most recent version.

Therefore, it is essential to verify how efficient the validity of the code generator tool is even when making a check of source code converted from the block diagram more efficient and starting usage of a new code generator tool.

### Solution to Problem

In order to resolve the above-described issues, the design assistance device for software of the present invention automatically generates a source code based on a block diagram describing a processing procedure for controlling the device for control by way of plural block elements and the connective relation between those plural block elements, the design assistance device for software creates a first data flow expressing the block elements and their connective relation by utilizing nodes and links and a second data flow expressing the dependent relation among variables or functions in the source code by utilizing links and nodes; and the design assistance device for software finds and outputs the coincidence between the first data flow and second data flow.

### Advantageous Effects of Invention

The present invention easily compares the source code with the block diagram serving as design information that is the origin of the source code and so can easily evaluate the validity of the code generator tool that is one part of the development environment even for large-scale and complex software (computer programs) as embedded systems.

The present invention can in this way simplify usage of automatic generating technology for source codes from block diagrams and the introduction of (new) code generating tools, and therefore can improve the overall software developmental efficiency.

### BRIEF DESCRIPTION OF DRAWINGS

FIG. 1 is a drawing showing the display screen of the design assistance device for software of an embodiment of the present invention.

FIG. 2 is a drawing showing a display screen of evaluation results of the code generator tool in an embodiment.

FIG. 3 is a drawing showing the overall structure of an embodiment of the present invention.

FIG. 4 is a drawing showing a block diagram management unit of an embodiment.

FIG. 5 is a drawing showing block diagram data for an embodiment.

FIG. 6 is a flow chart showing the processing by the block diagram management unit of an embodiment.

FIG. 7 is a drawing showing block diagram case data for an embodiment.

FIG. 8 is a drawing showing a source code management unit of an embodiment;

FIG. 9 is a flow chart showing the processing by the source code management unit of an embodiment.

FIG. 10 is a drawing showing a screen for setting source code generating conditions in an embodiment.

FIG. 11 is a drawing showing source code data of an embodiment.

FIG. 12 is a drawing showing source code case data of an embodiment.

FIG. 13 is drawing showing a data flow management unit of an embodiment.

FIG. 14 is a flow chart showing the processing by a block diagram analysis unit of an embodiment.

FIG. 15 is a drawing showing block diagram signal line data of an embodiment.

FIG. 16 is a drawing showing a data flow in an embodiment.

FIG. 17 is a flow chart showing the processing by a source code analysis unit in an embodiment.

FIG. 18 is a drawing showing source code variable data in an embodiment.

FIG. 19 is a drawing showing the processing by a data flow register unit of an embodiment.

FIG. 20 is a drawing showing data flow case data of an embodiment.

FIG. 21 is a drawing showing a coincidence analysis unit of an embodiment.

FIG. 22 is a flow chart showing the processing by the data flow selector unit of an embodiment.

FIG. 23 is a flow chart showing the processing by a coincidence measurement unit of an embodiment.

FIG. 24 is a drawing showing coincidence data of an embodiment.

FIG. 25 is a drawing showing an image display unit of an embodiment.

FIG. 26 is a flow chart showing the processing by an analysis result output unit of an embodiment.

FIG. 27 is a flow chart showing the processing by a code generator tool evaluation unit of an embodiment.

FIG. 28 is a flow chart showing the processing by an evaluation result output unit of an embodiment.

### DESCRIPTION OF EMBODIMENTS

The present invention relates to a design assistance device for software components of embedded systems that are incorporated into computer systems for achieving a specified function for components required in home appliances, industrial machinery, medical devices, and electronic control; and in particular is ideal for software development, verification and maintenance support of large-scale systems that are combinations of plural hardware pieces, plural software applications, and systems with multi-branched functions required for cellular telephones or digital appliances and also automobiles, construction equipment, and transportation equipment such as elevators. The present invention is a design assistance device for software that automatically converts processing procedures into source code by a machine language based on a block diagram expressing plural block elements and the connective relation between the block elements to provide the processing procedures, and in which the design assistance device creates a block diagram graph structure comprised of links and nodes expressing the connective relation with the block elements of the block diagram, and an automatically generated source code graph structure comprised of nodes and links expressing the dependent relation between variables within the source code; measures the degree of coincidence of the processing procedures of the automatically generated source code and the block diagram by comparing the two types of graph structures; and outputs the coincidence level to a destination outside the computer.

### First Embodiment

The first embodiment of the present invention is described next while referring to the drawings.

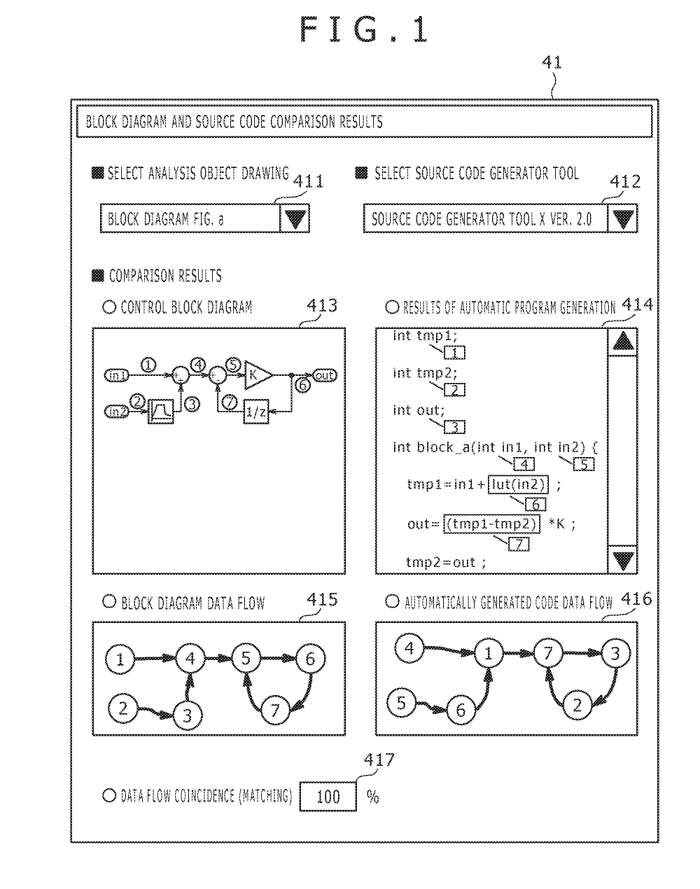

FIG. 1 is a drawing showing an example of the output screen of the design assistance system for software of the present invention. The design assistance system not only enters a block diagram and displays source code generation results converted from the block diagram but also interprets the connection between the block elements in the block diagram, and the dependent relation of the variables in the source code interpreted as a graph structure (data flow) comprised of node links, evaluates the coincidence level on the graph as markers, and displays the coincidence level on a screen such as on FIG. 1.

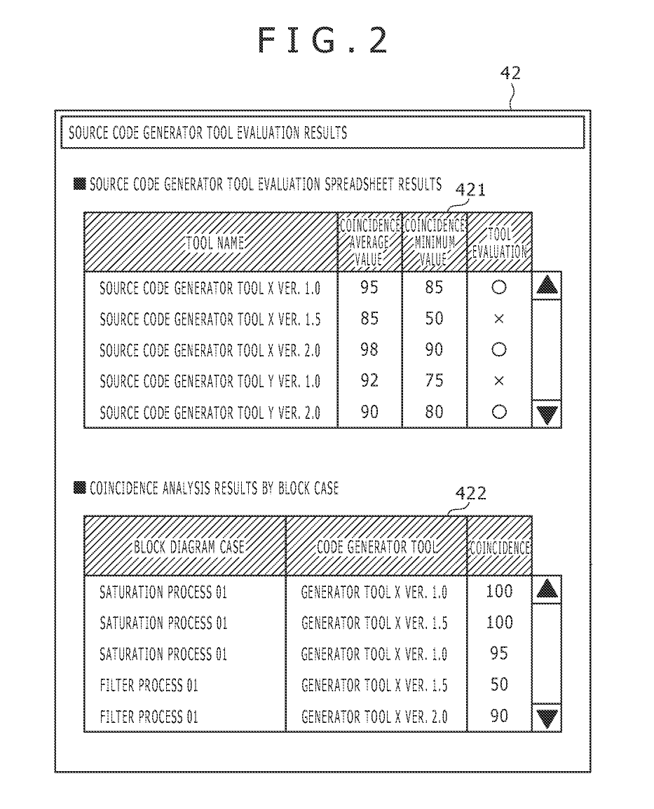

FIG. 2 is an example that displays evaluation results for the coincidence between each of block diagrams and source codes converted from those block diagrams per accumulated block diagram cases. Along with showing a list of information such as tool names specifying the code generator tool when making an evaluation, and coincidence markers for that information corresponding to each of the block diagram cases; the display screen also shows statistical information such as average values and minimum values for coincidence among all accumulated cases for each type of the code generator tool, and displays a screen to the user showing whether or not an evaluation is valid for the block diagram cases accumulated by the code generator tool. In this way, by displaying statistical information for each type of code generator tool, rather than just a coincidence marker for each block diagram case, information on the validity of the source generator tool can be obtained that has a higher degree of reliability. Moreover, the program performance efficiency in terms for example of memory capacity and the step count required when executing the generated source code may also be displayed.

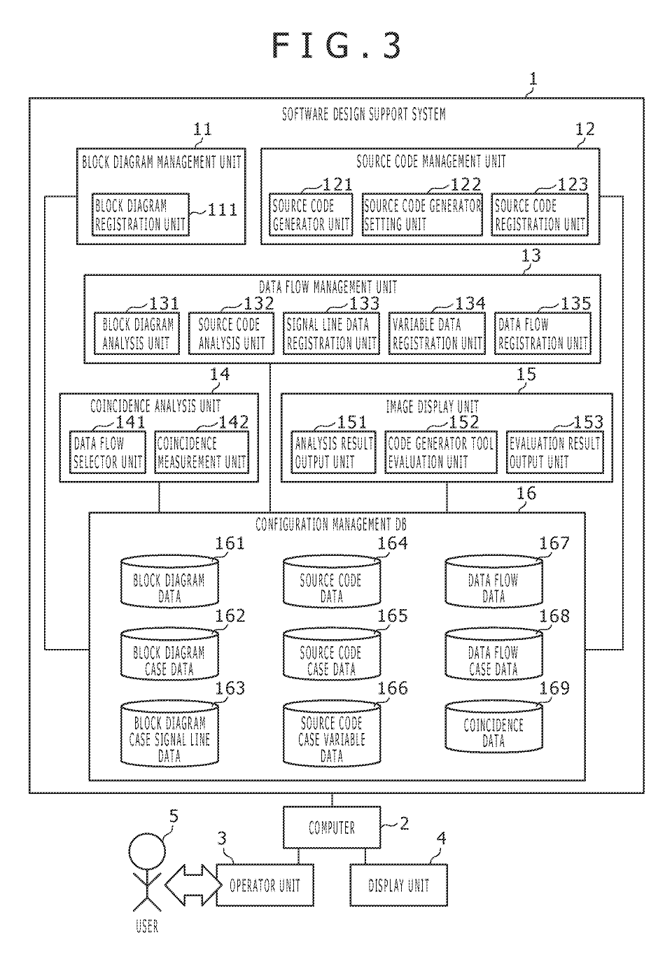

FIG. 3 is a drawing showing the overall structure of the design assistance system for software 1. The design assistance system for software 1 is comprised of a program including a block diagram management unit 11, a source code management unit 12, a data flow management unit 13, a coincidence analysis unit 14, and an image display unit 15, and further includes a configuration management DB 16 to store data that is input and output when this program is processed on computers. This configuration management DB is for example, a storage medium such as a RAM or a hard disk mounted within a computer 2. The block diagram management unit 11 is input by a block diagram data 161 stored in the configuration management DB 16, and outputs a block diagram case data 162 that manages the block diagram creation cases. The source code management unit 12 is input by block diagram data 161 and information selected from a source code generator setting unit 122 by a selecting operation by the user 5 utilizing an operator section 3, draws up the source code data 164 recorded in a programming language, and outputs a source code case data 165 relating to the source code generating conditions as conditions when the source code is generated. The data flow management unit 13 is input by the block diagram data 161 and outputs the block diagram case signal line data 163 as information on the signal line included in the block diagram, and data flow case data 168 showing the dependency relation of the signal line included in the block diagram. The data flow management unit 13 is input by source code data 164 and outputs the source code case variable data 166 as information for variables utilized in the source code, and data flow case data 168 showing the dependency relation of the variable utilized in the source code. The coincidence analysis unit 14 is input by source code case data 165 and data flow case data 168, and outputs coincidence data 169 as a marker showing the extent of coincidence among the data flows. The image display unit 15 is input by the block diagram case signal line data 163, the source code case variable data 166, the data flow case data 168, and the coincidence data 169, and outputs entry information to the display unit 4. The software design assistance system 1 may also be mounted in another computer coupled to a computer 2 that is utilized as a terminal by the user 5 over a network, and may be mounted within the computer 2.

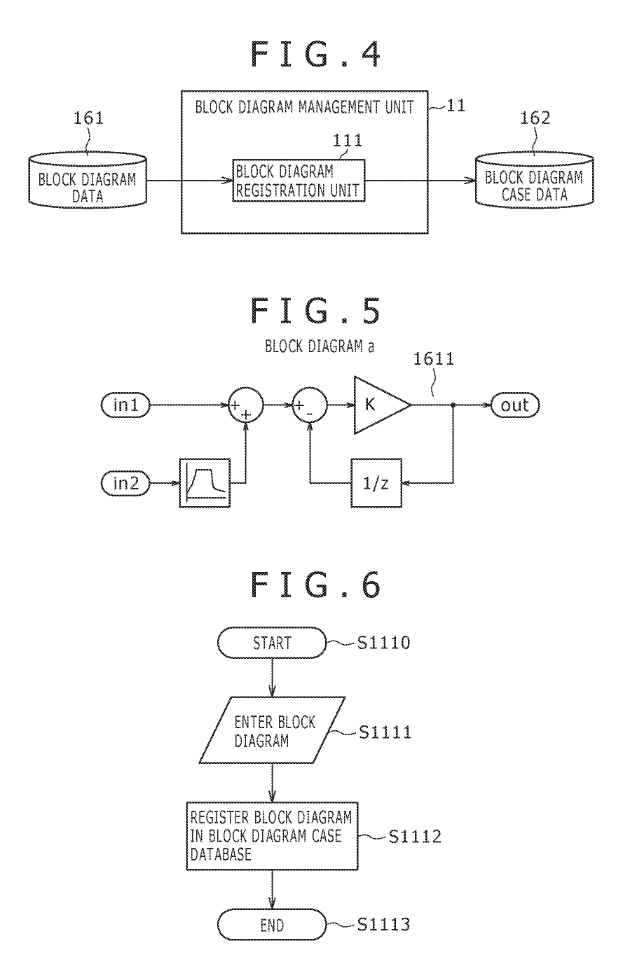

FIG. 4 is a drawing showing the detailed structure of the block diagram management unit 11. The block diagram management unit 11 contains a block diagram register unit 111 to register a block diagram that is newly stored in the block diagram data 161 into the block diagram case data 162. The block diagram management unit 11 is input by the block diagram stored in the block diagram data 161, and registers the block diagram data 161 into the block diagram case data 162 that serves as a database for linking the input block diagram data with each case and storing plural data. The link or correspondence with each case is determined from the file name of each block diagram. Entries into the block diagram management unit 11 are not always limited to the data stored in the configuration management DB 16 and may include block diagram data enter from over a network, etc.

FIG. 5 is a drawing showing the details of the block diagram data 161. The block diagram file 1611 shows the processing procedure for controlling plural blocks, and the device for control by way of signal lines between blocks. The block contains terminals for input or terminals for output. The output terminals of a block are always coupled by way of signal lines to input terminals of a block different from the block having the output terminal. Signal lines from the main terminals may branch and couple to plural input terminals, however the signal lines coming out from the plural output terminals merge, and are not coupled to one input terminal.

In the case of relay sequence type software for target objects for control that are devices such as elevators, the data from each signal lines is mostly one-bit information that is 0 or 1. On the other hand, in the case of software for control of automobiles, the data on each signal line is mostly physical quantities or control quantities. In the case of software for controlling engines for example, the input values are data from sensors such as an air flow sensor for detecting the intake air quantity to the engine and an accelerator pedal sensor for detecting the foot pressure on the accelerator, and are utilized to set the fuel injection quantity output value to the engine. In this case, the processing sequence or procedure for calculating the fuel injection quantity is shown in a block diagram.

The physical properties for each device for control are in this way reflected in the block diagram data 161.

FIG. 6 is a drawing showing the detailed operation flow of the block diagram register unit 111. The processing starts from step S1110. The input of the block diagram data 161 starts in step S1111. In step S1112, the input block diagram data 161 is linked to the name of the block diagram in the block diagram case data 162 and is registered. This linking can be implemented for example by acquiring the name of the block diagram from the file name of the block diagram stored in the block diagram data 161. The processing ends in step S1113.

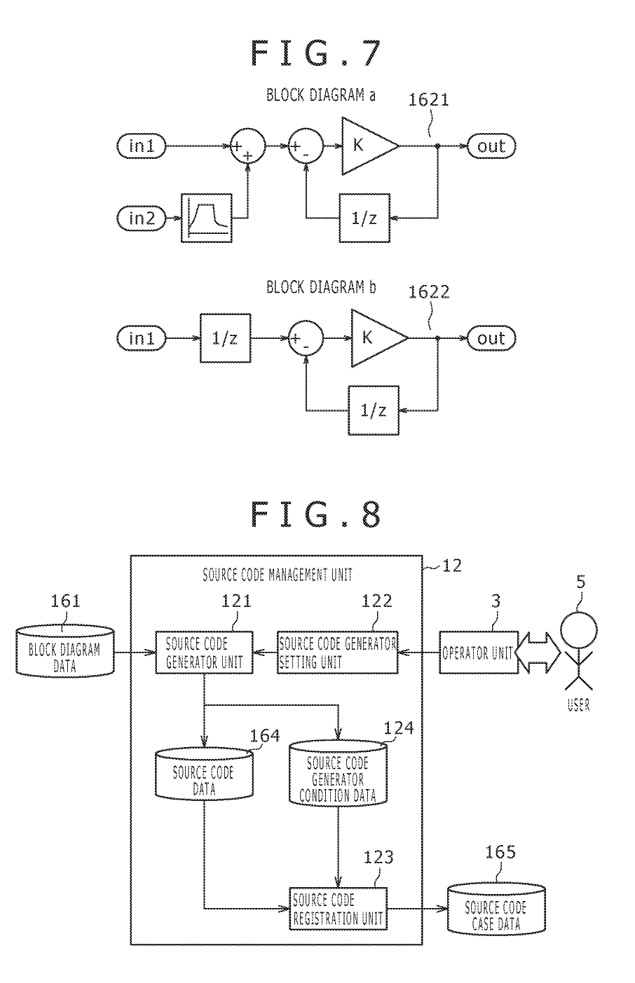

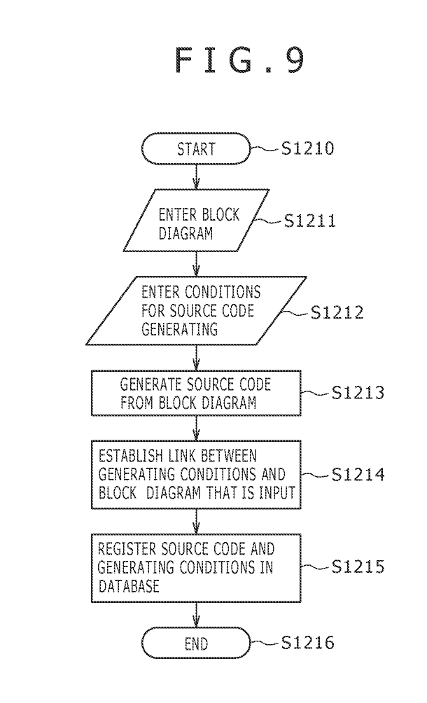

FIG. 7 is a drawing showing the block diagram case data 162 in detail. The block diagram file 1621 and the block diagram file 1622 both indicate respectively different block diagram files registered in the block diagram case data 162.

FIG. 8 is a drawing showing the detailed structure of the source code management unit 12. The source code management unit 12 contains a source code generator unit 121 into which she block diagram stored in the block diagram data 161 and the source code generating conditions selected in the source code generator setting unit 122 by the user 5 are input by way of the operation unit 3, and outputs the source code data 164 that implements she process shown in the block diagram by the source code utilizing a programming language and the source code generator condition data 124 that are the conditions when the source code is generated; and a source code registration unit 123 that registers the source code data 164 linking with the source code generator condition data 124 into the source code case data 165.

FIG. 9 is a flow chart showing in detail the execution of the flow in the source code management unit 12. The processing starts from step S1210. In step S1211, the input of the block diagram data 161 is performed. In step 1212, the input of the source code generating conditions selected in the source code generator setting unit 122 by the user 5 by way of the operation unit 3 is performed. In step S1213, the processing of the block diagram generates source code substituted into programming language according to the input generating conditions. In step S1214, the generated source codes are linked with the conditions during generating in step S1213. In step S1215, the generated conditions linked with the source code are registered in the source code case data 165 that serves as she database for the source code. The processing ends in step S1216.

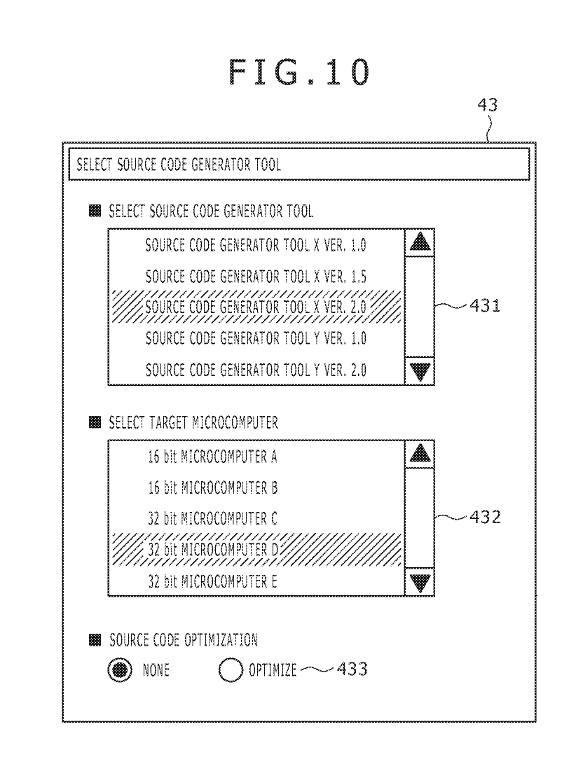

FIG. 10 is a drawing showing an example of the selection screen for the source code generator setting unit 122 that is selected by the user 5 by way of the operator unit 3. The user 5 utilizes the operation unit 3 to make selections such as the source code generating software used when generating source code from the block diagram, or hardware conditions such as the microcomputer that executes the source code, or optimizing settings to simplify the processing by eliminating redundant section in the source code.

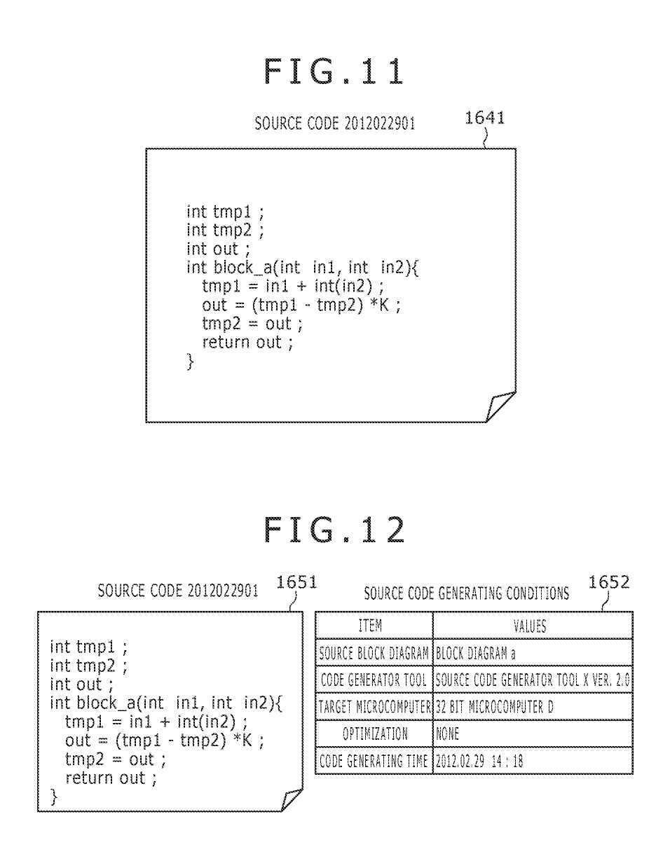

FIG. 11 is a drawing showing details of the source code data 164 The source code file 1641 is comprised of a processing procedure for function block_a corresponding to the block diagram data 1611. Information such as the time that the source code is generated is added for example to the file name of the source code file 1641 and non-redundant file names are attached.

FIG. 12 is a drawing showing details of the source code case data 165. The figure shows the source code file 1651 and the source code generating condition 1652 that are linked and registered in the source code case data 165. Besides the conditions selected in the source code generator setting unit 122, the source code generating condition 1652 also contains information specifying the block diagram data 161 that is the origin of the source code, and is capable of linking the source code with the block diagram.

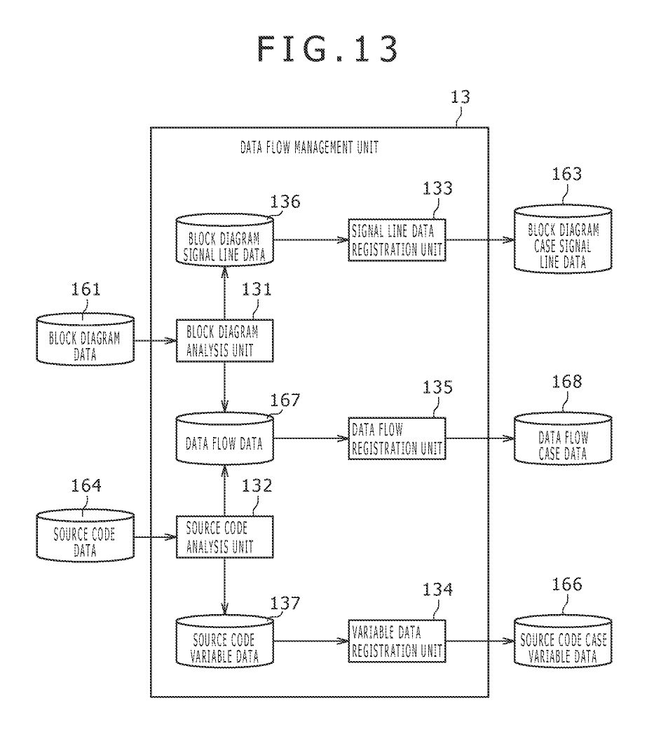

FIG. 13 is a drawing showing the detailed structure of the data flow management unit 13. The data flow management unit 13 is comprised of a block diagram signal line data 136 that is information regarding the signal lines extracted from the block diagram that is input, and a block diagram analysis unit 131 that outputs a data flow data 167 expressing the graph structure of the signal line dependency relation. The data flow management unit 13 is input by source code and includes a source code analysis unit 132 that outputs a source code variable data 137 that is information regarding variables that are extracted from the source code that is input, and outputs a data flow data 167 expressed in the graph structure of the signal line dependency relation. The output from the block diagram analysis unit 131 and the output from the source code analysis unit need not always be stored at the same location. The data flow management unit 13 includes a signal line data registration unit 133 that registers the block diagram signal line data 136 into the block diagram case signal line data 163, and a variable data registration unit 134 that registers the source code variable data 137 into the source code case variable data 166, and a data flow registration unit 135 that registers the data flow data 167 into the data flow case data 168.

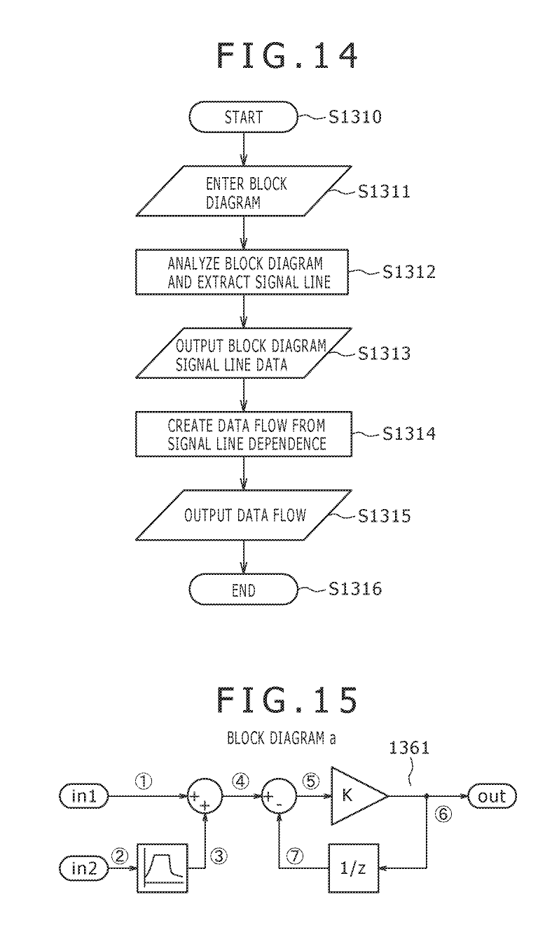

FIG. 14 is a flow chart showing in detail the execution of the flow in the block diagram analysis section 131. The process starts from step S1310. In step S1311, the input of the block diagram data 1611 is performed in step S1312, the block diagram that is input is analyzed and the signal line is extracted from the block diagram. In step S1313, the information for the signal line that is extracted is output as the block diagram signal line data 136. In step S1314, the dependency relation of the signal line that is extracted in step 1312 is analyzed and a data flow is made. In step S1315, the data flow that is made in step S1314 is output as the data flow data 167. The process ends in step 1316.

FIG. 15 is a drawing showing the details of the block diagram signal line data 136. The block diagram signal line data file 1361 is comprised of identification names attached so as not to be redundant in the signal lines contained within the block diagram file 1611.

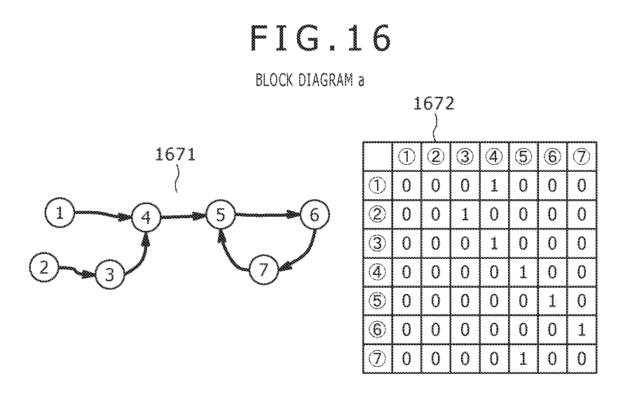

FIG. 16 is a drawing showing the details of the data flow data 167. The data flow 1671 expresses the signal lines contained in the block diagram file 1611 as the identification names that are stored in the block diagram signal line data file 1361, and expresses the dependency relation in a graph format. The matrix 1672 is a figure expressing the signal line dependency relation in a table format. In the present embodiment, the data flow 1671 expresses the signal line dependency relation as links shown by arrows indicating the corresponding relation of the input terminals and output terminals of the nodes and blocks for the signal lines. Here for example, in the drawing, nodes expressing the signal lines (1), (3), (4) and the links connecting between the nodes express that the signal line (1) and the signal line (3) are the inputs and the processing of signal line (4) by the block.

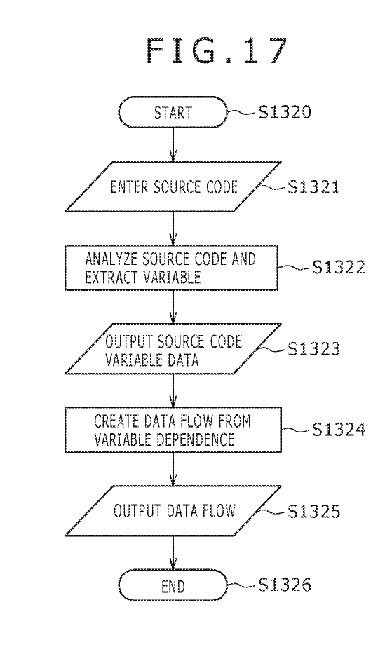

FIG. 17 is a flow chart showing in detail the execution of the flow in the source code analysis unit 132. The process starts from step 1320. In step S1321, the input of the source code 1651 is performed. In step 1322, the source that is input is analyzed and variables within the source code are extracted. In step 1323, information regarding the extracted variable is output as the source code variable data 137. In step S1324, the dependency relation of the variable extracted in step S1322 is analyzed, and the data flow is made. In step 1325, the data flow that is made in step S1324 is output as the data flow data 167. The process ends in step S1326.

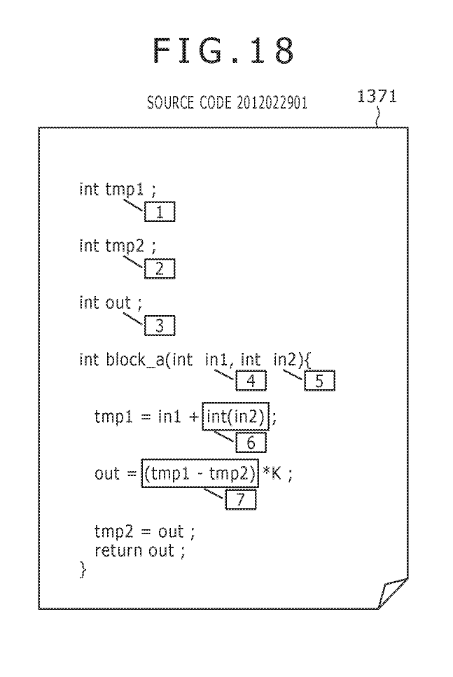

FIG. 18 is a drawing showing the details of the source code variable data 137. The source code variable data file 1371 is comprised of identification names attached so as not to be redundant for the locations where used as variables in the source code.

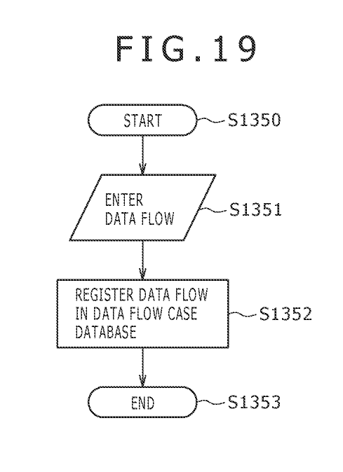

FIG. 19 is a flow chart showing in detail the execution of the flow in the data flow registration unit 135. The process starts from step S1350. In step S1351, the input of the data flow 1671 is performed. In step 1352, the data flow that is input is registered in the data flow case data 168 which is a database. The process ends in step S1353.

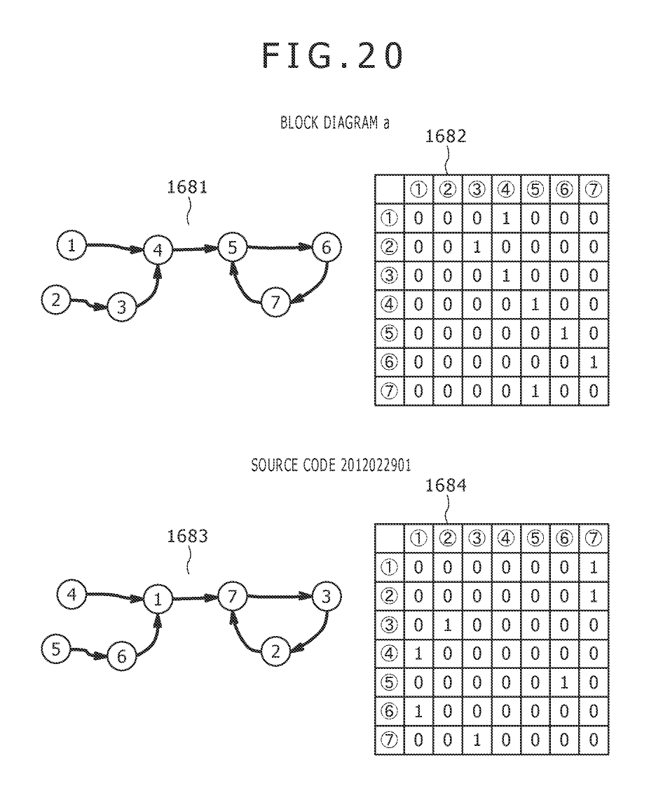

FIG. 20 is a drawing showing the details of the data flow case data 168. The data flow 1681 and the matrix 1682 are figures respectively expressing the dependency relation of the signal lines contained in the block diagram file 1611. The data flow 1683 and the matrix 1684 are figures respectively expressing the dependency relation of the variable contained in the source code file 1651. In this way, by expressing the dependency relation of the signal line of the block diagram, and the dependency relation of variables in the source code in the same format, the two can be easily compared.

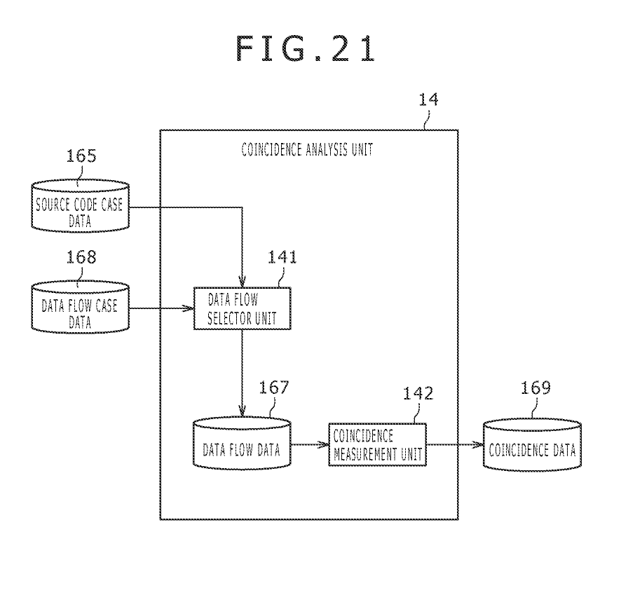

FIG. 21 is a drawing showing the detailed structure of the coincidence analysis unit 14. The source code case data 165 is input to the coincidence analysis unit 14. The coincidence analysis unit 14 is comprised of a data flow selector unit 141 that selects a data flow corresponding to the source code 1651 from the data flow case data 168; and a coincidence measurement unit 142 that measures the coincidence between the data flows, and outputs the measured coincidence to the coincidence data 169.

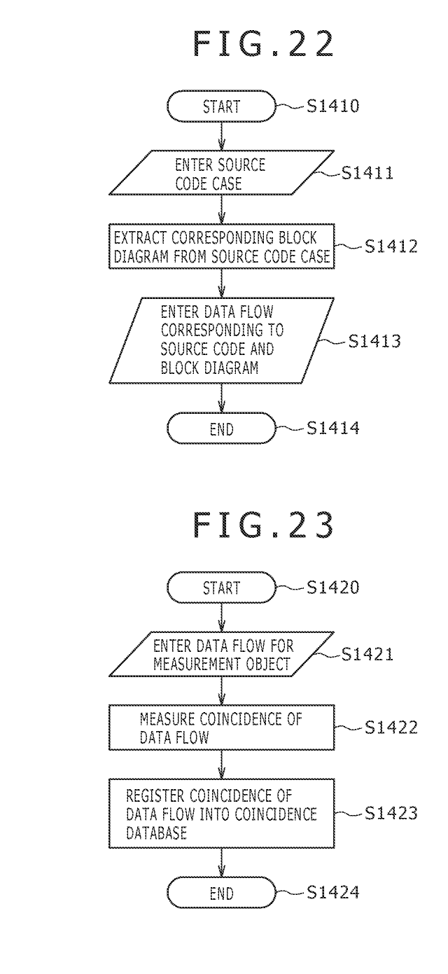

FIG. 22 is a flow chart showing in detail the execution of the flow in the data flow selector unit 141. The process starts from step S1410. In step S1411, the source code 1651 and the source code generating conditions 1652 are input from the source code case data 165. In step S1412, the block diagram that is the origin of the source code is specified from the source code generating conditions 1652 that are input. In step S1413, the source code 1651, and the data flow corresponding to the block diagram specified in step S1412 are input from the data flow case data 168. The process ends in step S1414.

FIG. 23 is a block diagram showing in detail the execution of the flow in the coincidence measurement unit 142. The process starts from step S1420. In step S1421, the input of the data flow serving as the object for measuring the coincidence is performed. In step S1422, the coincidence of the data flow that is input as the object for comparison is measured. Here, the coincidence of the data flow is considered the correlation coefficient, hamming distance, and centration resonance characteristics analysis. In step 1423, the coincidence of the measured data flow is registered in the coincidence data 169. The process ends in step S1424.

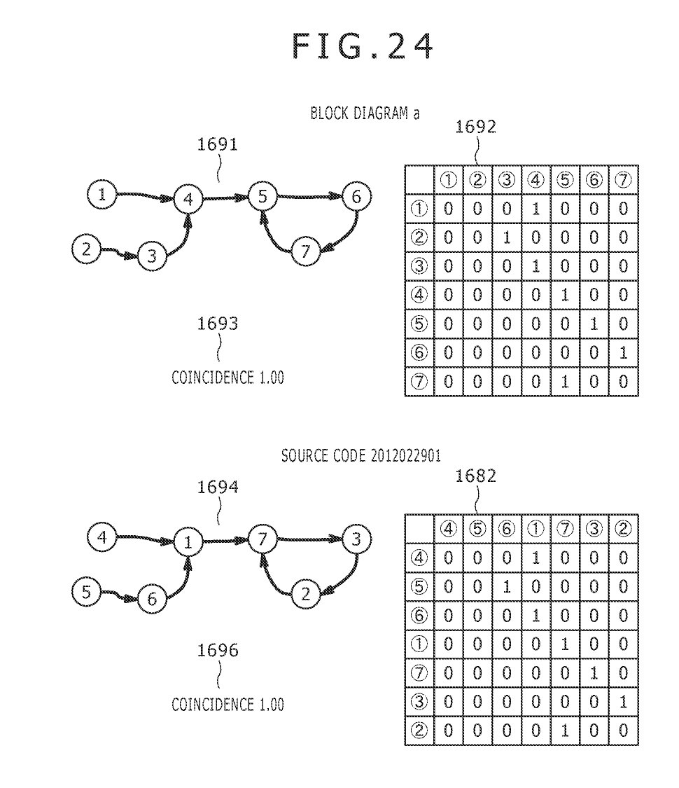

FIG. 24 is drawings showing details of the coincidence data 169. In the data flow 1691 and the matrix 1692, and the data flow 1694 and the matrix 1695, the identification names attached to the node are different. In the present embodiment, a linking is made between the nodes contained in both data flows and set as the data flow coincidence so that the coincidence between the data flow 1691 and the data flow 1694 will be the highest.

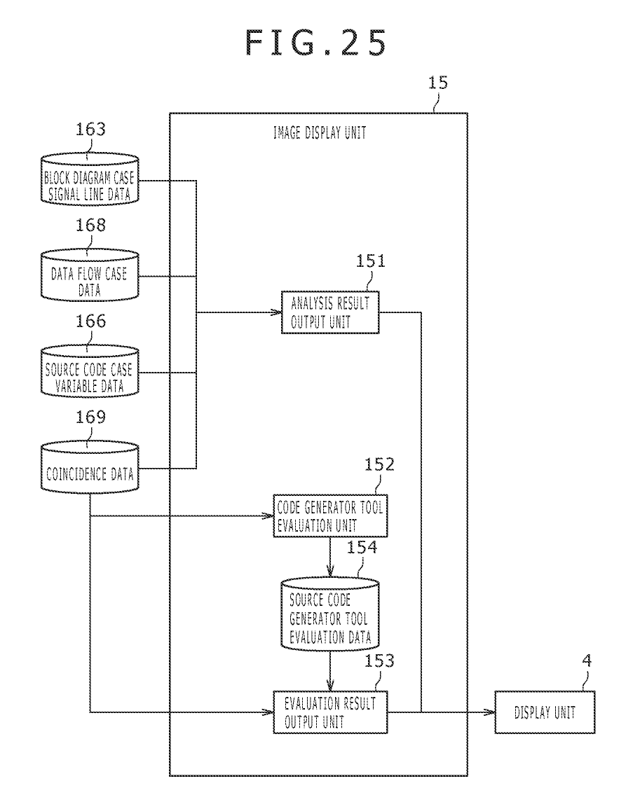

FIG. 25 is a drawing showing the detailed structure of the image display unit 15. The image display unit 15 includes an analysis result output unit 151 that inputs the block diagram case signal line data 163, the source code case variable data 166, the data flow case data 168, and the coincidence data 169 and outputs an image that is the analysis result shown on the display unit 4. The image display unit 15 further contains a code generator tool evaluation unit 152 that outputs the source code generator tool evaluation data 154 which is input with the coincidence data 169; and an evaluation result output unit 153 that jointly outputs the source code generator tool evaluation data 154 and the coincidence data 169 to the display unit 4. Here, the display unit 4 may be a display that is contained within the computer 2, and may be output means capable of being recognized by the user such as an output or print output obtained via a network or external computer, etc.

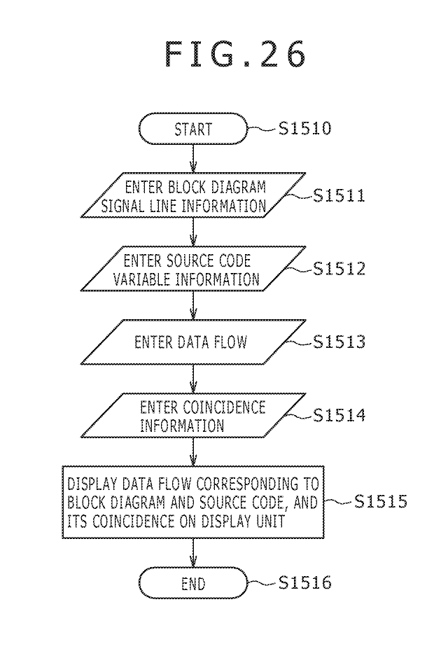

FIG. 26 is a block diagram showing in detail the execution of the flow in the analysis result output unit 151. The process starts from step S1510. In step S1511, the identification names of the signal lines in the block diagram are input from the block diagram signal line case data. In step S1512, the identification names of the variables within the source code are input from the source code case variable data 166. In step S1513, the block diagram that is input and the data flow corresponding to the source code are input from the data flow case data 168. In step S1514, the block diagram that is input and the coincidence among data flows corresponding to the source code are input from the coincidence data 169. In step S1515, the block diagram, the source code, the data flow, and the coincidence level input in step 1511, step S1512, step S1513, and step S1514 are output to the display unit 4. The block diagram and source code comparison results 41 in FIG. 1 is an example of this output display. The process ends in step S1516.

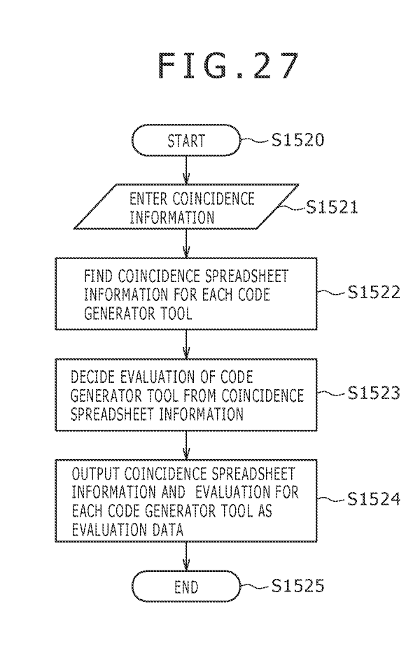

FIG. 27 is a flow chart showing in detail the execution of the flow in the code generator tool evaluation unit 152. The process starts from step S1520. In step S1521, the results from measuring the coincidence level contained in the coincidence data 169 are input. In step S1522, the coincidence level input in step S1521 is sorted into groups by code generating conditions contained in she source code generating conditions, and the statistical information for the coincidence level of each sorted group is calculated. Here, the statistical information is the average of the coincidence level, the minimum value, and the standard deviation, etc. In step S1523, the code generating conditions are evaluated based on statistical information for each type of coincidence level based on the code generating conditions that are found from step S1522. Here, the minimum value and standard deviation are within the certain range as the evaluation conditions. In step S1524, the statistical information and the evaluation results that are found in step S1522 and step S1523 are output as the source code generator tool evaluation data 154. The process ends in step S1525.

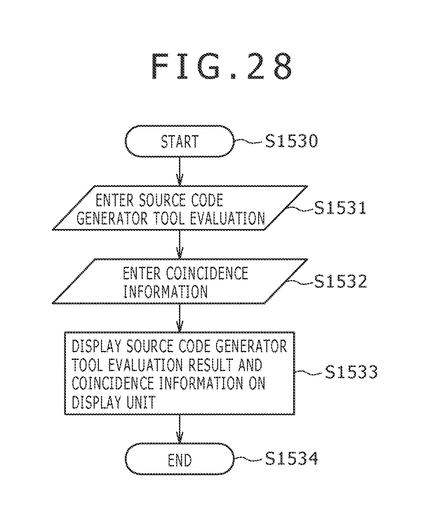

FIG. 28 is a flow chart showing in detail the execution of the flow in the evaluation result output unit 153. The process starts from step S1530. In step S1531, the source code generator tool evaluation unit 154 that is calculated in the code generator tool evaluation unit 152 is input. In step S1532, the measurement results for the coincidence level in the coincidence data 169 are input. In step S1533, the evaluation results for each sorted group of source code generating condition and the results from measuring the coincidence level for each data flow that are input in steps S1531 and step S1532 are output to the display unit 4. The source code generator tool evaluation results 42 in FIG. 2 are one display example of this output. The process ends in step S1534.

In this way in the present embodiment, markers whose algorithm are the same can be calculated by measuring the coincidence level of the data flow, even when the notation methods such as for the block diagram and source code are in different forms. When there are cases where the coincidence level of the data flow is drastically low, problems will be revealed in the process for generating the source code from the block diagram so that effects from changing the software that is used for generating the source code can be quickly recognized.

### Second Embodiment

Another embodiment of the present invention is described next focusing on the points differing from the first embodiment.

In the present embodiment, a source code generator unit 121 calls up a function equivalent to a block on the output terminal side from the function equivalent to a block on the input terminal side, in block pairs coupled by signal lines and utilizing the block contained in the block diagram data 161 as the function in order to generate the source code data 164. A block diagram analysis unit 131 makes a data flow that sets the blocks as the nodes and the signal lines as the links contained in the block diagram data 161 as the data flow data 167 and the data flow case data 168 that are registered in the configuration management DB 16. The source code analysis unit 132 also makes a data flow that sets the functions as the nodes and the call-up relation among the functions from the source code data 164. In this case, this action shows that the function expressed by a particular node calls up the function expressed by another node.

In the present embodiment, block diagrams themselves that are described by blocks and signal lines specifying the detailed process contents are handled as blocks. The degree of coincidence of source codes and block diagrams can therefore easily be known even in cases where the block diagram has a hierarchical structure such as when making a large-scale block diagram by utilizing plural block diagrams that are handled as these types of blocks.

### Third Embodiment

Another embodiment of the present invention is described next focusing on the points differing from the embodiments described up to now.

The present embodiment is applicable to the making of block diagrams while referring to source codes in embedded control equipment that controls target objects for control such as construction equipment, automobiles, and elevators. The block diagram that is made based on the source code is input as the block diagram data 161, and the original source code is input as the source code data 164 to the source code registration unit 123. The block diagrams and source codes input in this way are analyzed, and the data flow data 167 is created. The coincidence with the data flow corresponding to the block diagram and source code is compared, and the analysis result output unit 151 outputs the results to the display unit 4.

The present embodiment is capable of easily making block diagrams based on the source code, and making block diagrams capable of the same processing as the source code without errors. Source code maintenance can in this way be simplified by preparing a block diagram as design information even when utilizing previously existing source codes having no saved design information.

### Fourth Embodiment

Another embodiment of the present invention is described next focusing on the points differing from the embodiments described up to now.

The present embodiment is applicable to diagrams to express software structures such as class drawings specified by UML (Unified Modeling Language) as the block diagram data 161 other than block diagrams often utilized for control algorithms in embedded control equipment that controls devices for control such as construction equipment, automobiles, and elevators. A class diagram is input as the block diagram data 161 to the block diagram analysis unit 131. The block diagram analysis unit 131 creates a data flow that sets the classes as the nodes, and the relation between classes as the link using the data flow data 167 and the data flow case data 168 that is registered in the configuration management DB 16. The source code generator unit 121 generates the source code data 164 by way of a programming language that contains the principles of the class, from a class diagram that is input as the block diagram data 161. The source code analysis unit 132 extracts sections noted as a class from the source code data 164, and creates a data flow that sets the classes as the nodes and the dependency relation between classes as the links.

The present embodiment is capable of calculating markers having the same structure by comparing the coincidence level of the data flow in UML class diagrams and source code structures that express software structures. Whether or not the software is made just as per the design can easily be known, and if there is a change in the design, a check can easily be made to determine if the software follows up on this change.

The embodiments of the present invention are described above. However, the present invention shown in these embodiments should each be regarded as a combination for the purpose of convenience rather than interpreted as independent entities. It is also clearly evident that these combinations do not require trial-and-error efforts by one skilled in the art.

### LIST OF REFERENCE SIGNS

1 Software design assistance system
2 Computer
3 Operation unit
4 Display unit
5 User
11 Block diagram management unit
12 Source code management unit
13 Data flow management unit
14 Coincidence analysis unit
15 Image display unit
16 Configuration management DB
111 Block diagram registration unit
121 Source code generator unit
122 Source code generator setting unit
123 Source code registration unit
131 Block diagram analysis unit
132 Source code analysis unit
133 Signal line data registration unit
134 Variable data registration unit
135 Data flow registration unit
141 Data flow selector unit
142 Coincidence measurement unit
151 Analysis result output unit
152 Code generator tool evaluation unit
153 Evaluation result output unit
161 Block diagram data
162 Flock diagram case data
163 Block diagram case signal line data
164 Source code data
165 Source code case data
166 Source code case variable data
167 Data flow data
168 Data flow case data
169 Coincidence data

1. A design assistance device for software that automatically generates a source code based on a block diagram describing a processing procedure for controlling devices for control by way of a plurality of block elements and the connective relation between the block elements;
wherein the design assistance device for software creates:
a first data flow expressing the block elements and their connective relation by utilizing nodes and links; and
a second data flow expressing the dependency relation among functions or variables in the source code by utilizing nodes and links, and
the design assistance device for software finds and outputs the coincidence between the first data flow and the second data flow.

2. The design assistance device for software according to claim 1, comprising a plurality of code generating software applications in order to generate a source code from a block diagram,
wherein the design assistance device for software links information specifying the code generating software for generating the source code with the source code that is generated, and registers the link.

3. The design assistance device for software according to claim 2, wherein the coincidence for block diagram cases is statistically processed and output for each of the code generating software applications from the coincidence markers for source code corresponding to the accumulated block diagram cases.

4. The design assistance device for software according to claim 2, wherein the evaluation results for the code generating software are output based on the coincidence of the accumulated block diagram cases and the source code converted from each of the accumulated block diagram cases.

5. The design assistance device for software according to claim 1, wherein the source code efficiency such as memory capacity and number of steps required when loading the generated source code into the computer as a judgment marker for the generated source code converted from the block diagram is displayed.

6. The design assistance device for software according to claim 1, wherein the coincidence with the first data flow and the second data flow is found by utilizing one among at least the correlation coefficient, hamming distance, and centration resonance characteristics analysis.

7. The design assistance device for software according to claim 3, wherein the statistical processing is at least one among the standard deviation, the minimum value, and the average of the coincidence level.

8. The design assistance device for software according to claim 1, wherein the block diagram is generated based on the existing source code.

9. A design assistance device for software that automatically generates a source code based on a class diagram describing a processing procedure for controlling devices for control by way of a plurality of classes and the relation between the classes;
wherein the design assistance device for software creates: a first data flow expressing the classes and their connective relation by utilizing nodes and links; and
a second data flow expressing the dependency relation among functions or variables in the source code by utilizing nodes and links, and
the design assistance device for software finds and outputs the coincidence between the first data flow and the second data flow.
